(19) United States
(12) Patent Application Publication
(10) Pub. No.: US 2017/0106534 A1
(43) Pub. Date: Apr. 20, 2017

(54) TRANSPORTER AND TRANSPORT METHOD

(71) Applicant: Kabushiki Kaisha Toshiba, Minato-ku (JP)

(72) Inventors: Hideichi NAKAMOTO, Setagaya (JP); Akihito Ogawa, Fujisawa (JP); Junya Tanaka, Ota (JP); Takafumi Sonoura, Yokohama (JP); Haruna Eto, Kawasaki (JP); Rie Katsuki, Kawasaki (JP)

(73) Assignee: Kabushiki Kaisha Toshiba, Minato-ku (JP)

(21) Appl. No.: 15/258,698

(22) Filed: Sep. 7, 2016

(30) Foreign Application Priority Data
Sep. 9, 2015 (JP) 2015-177879

(51) Int. Cl. B25J 9/16; B25J 15/06; B25J 9/14; B25J 9/10; B65G 15/00; B65G 47/91

(52) U.S. Cl. CPC B25J 9/1633; B65G 15/00; B65G 47/91; B25J 9/144; B25J 9/1075; B25J 15/0616; B25J 9/142; B25J 9/1638; Y10S 901/02; Y10S 901/09

(57) ABSTRACT

According to one embodiment, a transporter includes a holder, a joint, an actuator, and a controller. The holder is configured to hold an object. The joint is configured to support the holder and to allow a change in posture of the holder. The actuator is configured to output a force suppressing a movement of the joint. The controller is configured to change stiffness of the joint by controlling an amount of the force.

### CROSS-REFERENCE TO RELATED APPLICATION

This application is based upon and claims the benefit of priority from Japanese Patent Application No. 2015-177879, filed Sep. 9, 2015; the entire contents of which are incorporated herein by reference.

### FIELD

Embodiments described herein relate generally to a transporter and a transport method.

### BACKGROUND

A cargo handling apparatus which automatically performs unloading of cargoes is known. The cargo handling apparatus holds and conveys the cargoes by a holder provided at the end of a robot arm, for example.

Regarding the above-mentioned apparatus, a reduction in size of the apparatus is expected.

### BRIEF DESCRIPTION OF THE DRAWINGS

FIG. 1 is a perspective view showing a transporter of a first embodiment.

FIG. 2 is a diagram showing the transporter of the first embodiment.

FIG. 3 is a diagram showing a pneumatic actuator and a controller of the first embodiment.

FIG. 4 is a flowchart showing an operation flow of the transporter of the first embodiment.

FIG. 5 is a sectional view showing a usage example of the transporter of the first embodiment.

FIG. 6 is a sectional view showing a transporter of a second embodiment.

FIG. 7 is a sectional view showing a transporter of a third embodiment.

FIG. 8 is a side view showing a suction pad unit of the third embodiment.

FIG. 9 is a sectional view showing a usage example of the transporter of the third embodiment.

FIG. 10 is a plan view showing a transporter of a fourth embodiment.

FIG. 11A is a block diagram showing a system configuration of a controller of the fourth embodiment.

FIG. 11B is a block diagram showing a system configuration of the controller of the fourth embodiment.

FIG. 11C is a block diagram showing a system configuration of the controller of the fourth embodiment.

FIG. 12A is a plan view showing a transporter of a fifth embodiment.

FIG. 12B is a plan view showing a pneumatic artificial muscle actuator of the fifth embodiment.

FIG. 13 is a diagram view showing a transporter of a sixth embodiment.

FIG. 14 is a diagram view showing a transporter of a seventh embodiment.

### DETAILED DESCRIPTION

According to one embodiment, a transporter includes a holder, a joint, an actuator, and a controller. The holder is configured to hold an object. The joint is configured to support the holder and to allow a change in posture of the holder. The actuator is configured to output a force suppressing a movement of the joint. The controller is configured to change stiffness of the joint by controlling an amount of the force.

Hereinafter, transporters and transport methods of embodiments will be described with reference to the drawings. In the following description, the configurations having the same or similar functions will be assigned the same reference numerals. The redundant description thereof may be omitted.

### First Embodiment

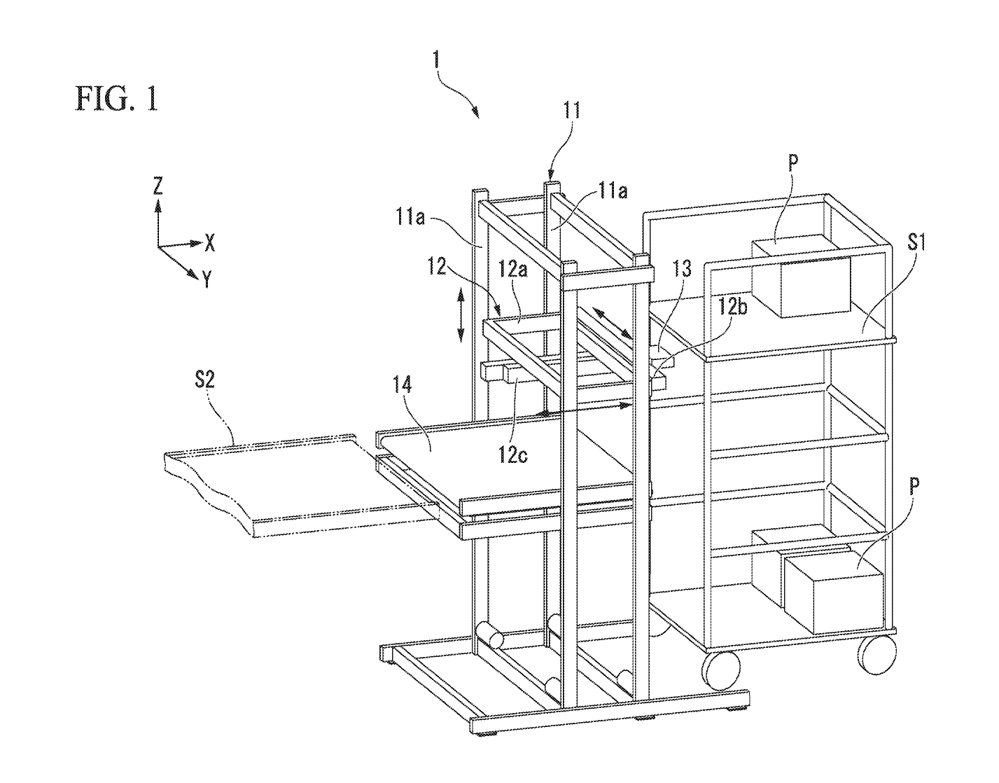

A first embodiment will be described with reference to FIGS. 1 to 5.

FIG. 1 is a perspective view showing a transporter 1 of this embodiment.

As shown in FIG. 1, the transporter 1 is, for example, an automatic unloading apparatus. That is, the transporter 1 takes out an object P placed on a first load section S1 and moves the object P to a second load section S2. The first load section S1 is, for example, a load surface of a dolly (e.g., box pallet). However, the first load section S1 may be a conveying surface of a belt conveyor, or the like. The second load section S2 is, for example, a conveying surface of a belt conveyor. However, the second load section S2 may be a load surface of another dolly, a floor surface, or the like. Further, the configuration of this embodiment is not limited to an automatic unloading apparatus and may be broadly applied to a transporter which is used in a variety of situations. In this embodiment, the transporter 1 may be called a “cargo handling apparatus”.

Here, for convenience of description, an X-direction, a Y-direction, and a Z-direction are defined as follows. The X-direction is a direction toward the first load section S1 from the transporter 1. The Y-direction is a direction crossing (for example, a direction substantially orthogonal to) the X-direction and is, for example, a width direction of the object P. The Z-direction is a direction crossing (for example, a direction substantially orthogonal to) the X-direction and the Y-direction and is, for example, a vertical direction.

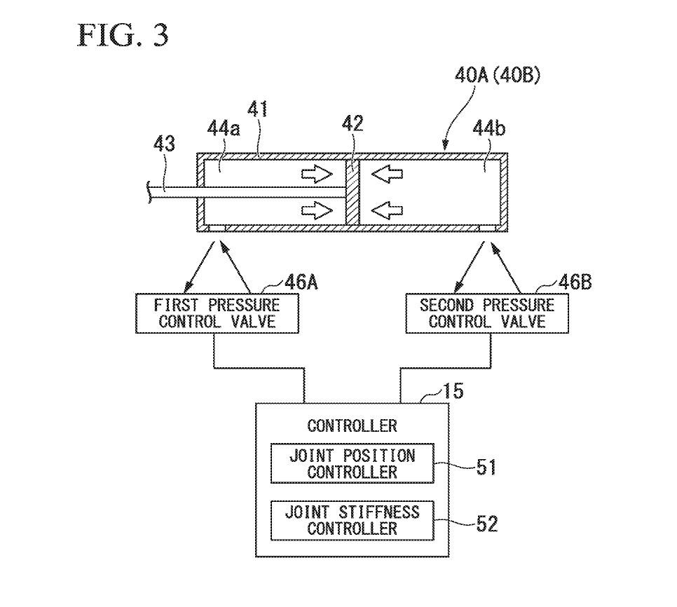

As shown in FIG. 1, the transporter 1 includes a main frame 11, a robot arm 12, an end effector 13, a conveyer 14, and a controller 15 (refer to FIG. 3).

The main frame 11 is installed on a floor surface and the position thereof is fixed. The main frame 11 includes a plurality of supports 11a extending in the Z-direction and is formed in a frame shape, for example. The main frame 11 supports the robot arm 12 and the conveyer 14, which will be described later.

The robot arm (e.g., an orthogonal robot arm) 12 is an example of a multi joint arm. An “arm” or “arm device” as referred to in this application broadly means a member which moves the end effector 13 to a desired position and is not necessarily limited to a rod-shaped member. For this reason, the robot arm 12 may be referred to as a “moving mechanism” or a “support mechanism” which moves the end effector 13.

The robot arm 12 of this embodiment includes an arm base 12a which can be moved along the Z-direction by being guided by guides provided at the plurality of supports 11a of the main frame 11. Further, the robot arm 12 includes a first member 12b movable along the Y-direction, and a second member 12c movable along the X-direction. In this way, the robot arm 12 can move the end effector 13 to desired positions in the X-direction, the Y-direction, and the Z-direction.

The end effector 13 is provided at an end of the robot arm 12. The end effector 13 includes a holder which holds the object P. The end effector 13 is moved toward the first load section S1 by the robot arm 12 and holds the object P placed on the first load section S1. Further, the end effector 13 is moved by the robot arm 12, thereby conveying the held object P toward the conveyer 14 described later. The end effector 13 releases the holding with respect to the object P in a state where the object P has been placed on the conveyer 14. In this way, the transporter 1 moves the object P placed on the first load section S1 to the conveyer 14. The end effector 13 will be described in detail later.

The conveyer 14 is provided at least in part in the main frame 11. An example of the conveyer 14 is a belt conveyor which is disposed toward the second load section S2. The conveyer 14 transports the object P placed on the conveyer 14 to the second load section S2. The transporter 1 may not include the conveyer 14. That is, the transporter 1 may directly move the object P placed on the first load section S1 to the second load section S2 by using the robot arm 12 and the end effector 13.

The controller 15 (refer to FIG. 3) controls the overall operation of the transporter 1. That is, the controller 15 controls various operations of the robot arm 12, the end effector 13, and the conveyer 14. The controller 15 will be described in detail later.

Next, the end effector 13 of this embodiment will be described in detail.

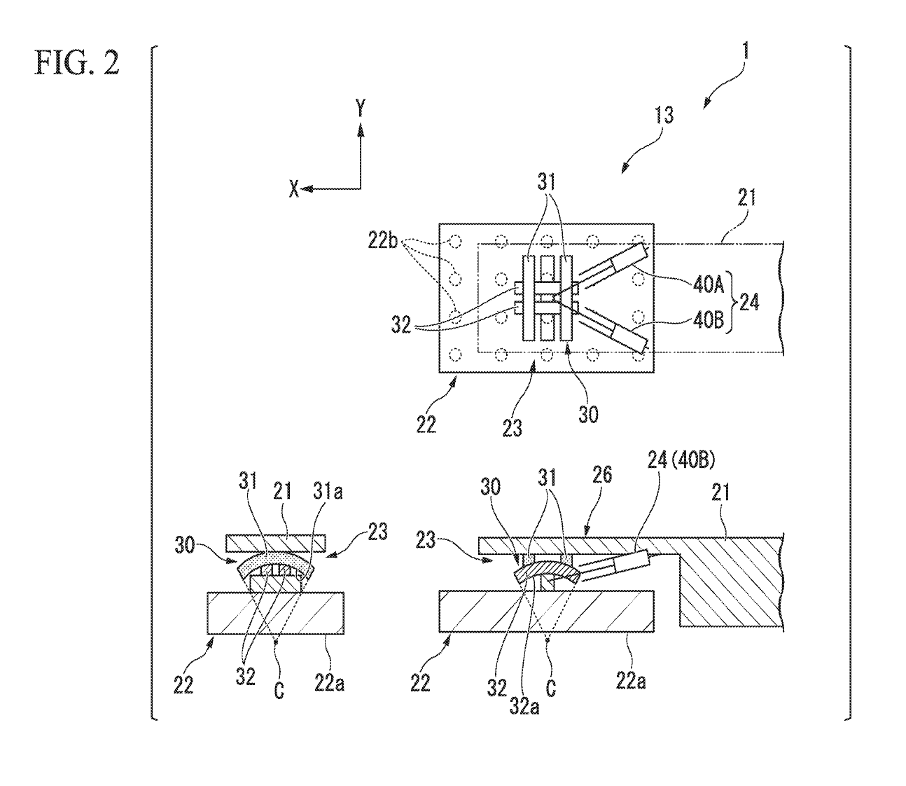

FIG. 2 is a diagram showing the end effector 13.

As shown in FIG. 2, the end effector 13 of this embodiment includes a frame 21, a suction unit 22, a joint 23, and an actuator 24.

The frame 21 is a holder supporting the suction unit 22 described later. The frame 21 is provided at the end of the robot arm 12 and supported by the robot arm 12.

The suction unit 22 is an example of a “holder” which holds the object P. Further, the suction unit 22 is an example of a “suction mechanism” which suctions and holds the object P. For example, the suction unit 22 includes a holding surface 22a which comes into contact with the object P, and a plurality of suction holes 22b which are open in the holding surface 22a. The suction unit 22 suctions and holds the object P by the suction holes 22b being vacuum suctioned by a tube, a pump, and the like (none of which is shown).

The “holder” as referred to in this application is not limited to the suction unit 22. The holder may be a holder which holds the object P by mechanically gripping the object P, or a holder which holds the object P by an electromagnetic force or the like. In another view point, the end effector 13 may be called a “grasper” which grasps the objects. However, the wording “grasping” as referred to in this application is used in a broad sense of “taking object” and is not limited to a meaning such as “mechanically gripping”.

The joint 23 is provided between the frame 21 and the suction unit 22 and connects the frame 21 and the suction unit 22. In other words, the joint 23 forms a part of a connector 26 which connects the robot arm 12 and the suction unit 22. Further, the transporter 1 may have a configuration in which it does not include the frame 21, and the joint 23 may directly connect the robot arm 12 and the suction unit 22.

As shown in FIG. 2, the joint 23 is connected to the suction unit 22 and supports the suction unit 22. The joint 23 includes a movable coupling section and allows a change in posture of the suction unit 22 with respect to the robot arm 12. That is, the suction unit 22 is supported by the joint 23, thereby being able to be tilted at various angles with respect to the robot arm 12. The “posture” as referred to in this application means an overall orientation or a tilt of a certain form.

The joint 23 of this embodiment includes, for example, a goniometer guide 30 having two degrees of freedom. The goniometer guide 30 is a guide mechanism having a sliding surface formed in a curved shape. The goniometer guide 30 of this embodiment includes a first guide 31 and a second guide 32.

As shown in FIG. 2, the first guide 31 is fixed to the frame 21. The first guide 31 includes a first sliding surface 31a having a curved surface shape. The first sliding surface 31a is formed in, for example, an arc shape centered on a central axis along the X-direction.

The second guide 32 is supported by the first guide 31. The second guide 32 can move arcuately along the first sliding surface 31a of the first guide 31. Further, the second guide 32 includes a second sliding surface 32a having a curved surface shape. The second sliding surface 32a is formed in, for example, an arc shape centered on a central axis along the Y-direction.

The suction unit 22 is supported by the second guide 32. The suction unit 22 can move arcuately along the second sliding surface 32a of the second guide 32.

In this way, the suction unit 22 can perform a rotational motion having two degrees of freedom with a rotation center C, which is located in the vicinity of the holding surface 22a, as the center. That is, the suction unit 22 can change the posture with respect to the robot arm 12 along the first sliding surface 31a of the first guide 31 and along the second sliding surface 32a of the second guide 32.

Next, the actuator 24 will be described.

The actuator 24 is a driver which drives the joint 23. The wording “driving a joint” as referred to in this application includes not only a case of being connected to the joint 23, thereby directly driving the joint 23, but also a case of changing the state of the joint 23 by applying a force to a member connected to the joint 23, or the like. For example, in this embodiment, the actuator 24 is provided between the frame 21 and the suction unit 22 and is connected to the frame 21 and the suction unit 22. The actuator 24 drives the joint 23 by applying a force to the frame 21 and the suction unit 22.

Further, the actuator 24 of this embodiment can output a force which suppresses movement of the joint 23 so as to provide stiffness to the joint 23. The “force suppressing the movement of a joint” is a force fixing the movement of the joint 23 and is a force maintaining the posture of the suction unit 22.

Further, the “stiffness” as referred to in this application means the property of an object is not easily deformed by an external force. The “stiffness of a joint” as referred to in this application means the difficulty of deformation of a joint by an external force and indirectly means the difficulty of a change in posture of a suction unit (i.e., a holder) by an external force.

Next, a configuration example of the actuator 24 of this embodiment will be described.

The actuator 24 of this embodiment includes a plurality of pneumatic actuators 40A and 40B. Each of the pneumatic actuators 40A and 40B is, for example, a double-acting cylinder.

FIG. 3 shows the pneumatic actuator 40A or 40B which is a double-acting cylinder.

As shown in FIG. 3, each of the pneumatic actuators 40A and 40B includes a cylinder case 41, a piston 42, and a rod 43. The inside of the cylinder case 41 is partitioned into a first chamber 44a and a second chamber 44b by the piston 42.

A first pressure control valve (i.e., a first pressure controller) 46A is connected to the first chamber 44a. The first pressure control valve 46A takes air into and out of the first chamber 44a. thereby controlling the pressure in the first chamber 44a. Similarly, a second pressure control valve (i.e., a second pressure controller) 46B is connected to the second chamber 44b. The second pressure control valve 46B takes air into and out of the second chamber 44b, thereby controlling the pressure in the second chamber 44b. Further, the rod 43 is connected to the piston 42 and advances and retreats with respect to the cylinder case 41 according to the movement of the piston 42.

In this embodiment, by controlling the first pressure control valve 46A and the second pressure control valve 46B, it is possible to control a difference in pressure between the first chamber 44a and the second chamber 44b. By controlling the difference in pressure, it is possible to advance and retreat the piston 42 and the rod 43 with respect to the cylinder case 41, or control a generative force on the piston 42. Here, as shown in FIG. 2, the cylinder case 41 is attached to the frame 21. On the other hand, an end portion on the protrusion side of the rod 43 is attached to the suction unit 22. For this reason, if the rod 43 advances and retreats with respect to the cylinder case 41, the joint 23 is driven, whereby the posture of the suction unit 22 with respect to the robot arm 12 changes. In other words, the actuator 24 outputs an adjustment force adjusting the posture of the suction unit 22.

As shown in FIG. 2, the plurality of pneumatic actuators 40A and 40B are disposed to be separated in the Y-direction. Further, the plurality of pneumatic actuators 40A and 40B are inclined to the opposite sides to each other with respect to the X-direction. For this reason, the rods 43 of the plurality of pneumatic actuators 40A and 40B advance and retreat along the directions different from each other. For this reason, the suction unit 22 can perform a rotational motion having two degrees of freedom with the above-described rotation center C as the center by the driving of the pneumatic actuators 40A and 40B.

Further, in this embodiment, substantially the same pressure is supplied to the first chamber 44a and the second chamber 44b, whereby a retention force retaining the piston 42 in a constant position is generated by compressed air in the first chamber 44a and compressed air in the second chamber 44b. Each of the pneumatic actuators 40A and 40B outputs a force suppressing the movement (e.g., rotation) of the joint 23 between the suction unit 22 and the frame 21 by the retention force. That is, the pneumatic actuators 40A and 40B provide stiffness to the joint 23 by the retention force. In the following description, a case of being referred to as a “retention force of an actuator” refers to the above-described retention force.

Next, the controller 15 will be described in detail.

As shown in FIG. 3, the controller 15 of this embodiment includes a joint position controller 51 and a joint stiffness controller 52.

The joint position controller 51 drives the pneumatic actuators 40A and 40B, thereby driving the joint 23. That is, the joint position controller 51 controls a first pressure which is supplied to the first chamber 44a and a second pressure which is supplied to the second chamber 44b, thereby generating a force based on a difference in pressure between the first chamber 44a and the second chamber 44b. The joint position controller 51 advances and retreats the rod 43 with respect to the cylinder case 41 by the force based on the difference in pressure. In this way, the joint position controller 51 changes the posture of the suction unit 22 with respect to the robot arm 12 by moving the joint 23.

On the other hand, the joint stiffness controller 52 controls the amount of the retention forces of the pneumatic actuators 40A and 40B, thereby controlling the stiffness of the joint 23. For example, in this embodiment, the joint stiffness controller 52 changes the above-described retention forces by changing the first pressure which is supplied to the first chamber 44a and the second pressure which is supplied to the second chamber 44b, by substantially the same amount, of the pneumatic actuators 40A and 40B. For example, the joint stiffness controller 52 increases the retention force by increasing the pressure in each of the chambers 44a and 44b of the pneumatic actuators 40A and 40B. In this way, the stiffness of the joint 23 is increased. Further, the joint stiffness controller 52 reduces the retention force by reducing the pressure in each of the chambers 44a and 44b of the pneumatic actuators 40A and 40B. In this way, the stiffness of the joint 23 is reduced.

The controller 15 of this embodiment changes the state of the joint 23 to at least a first state and a second state where the stiffness is large, compared to that in the first state, through the control as described above. The first state is a state in which the stiffness of the joint 23 is relatively small, and is, for example, a state in which an external force acts on the suction unit 22, the posture of the suction unit 22 is passively changed by the external force. On the other hand, the second state is a state in which the stiffness of the joint 23 is relatively large, and is, for example, a state in which even if an external force acts on the suction unit 22, the posture of the suction unit 22 does not substantially change.

Next, the flow of a control operation of the controller 15 and transport method of this embodiment will be described.

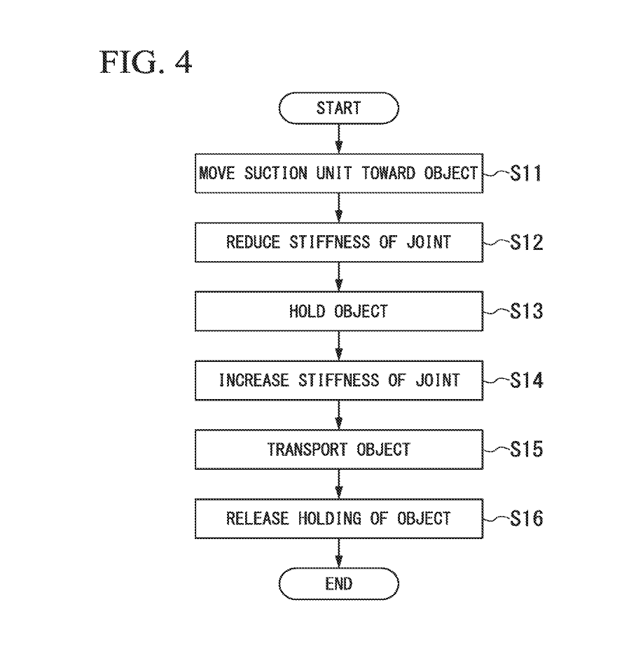

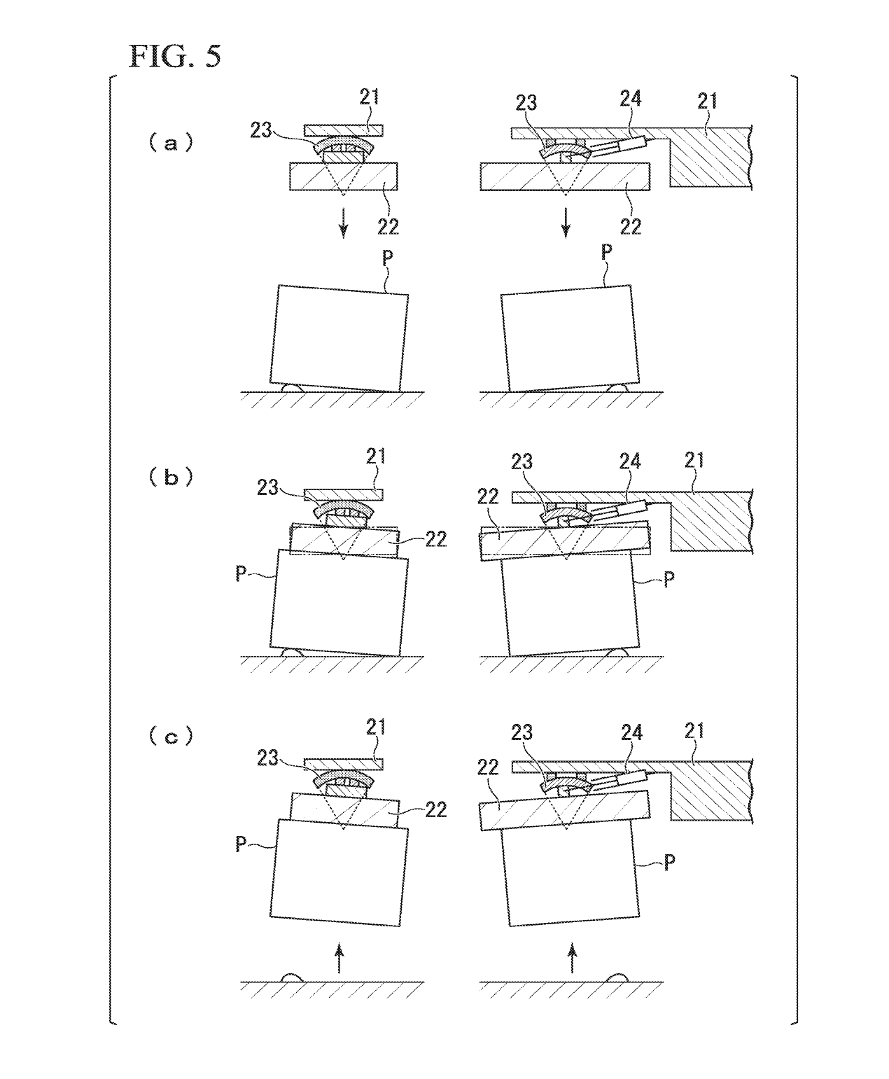

FIG. 4 is a flowchart showing an example of the flow of a control operation of the controller 15. Further, FIG. 5 is a diagram showing a usage example of the transporter 1 of this embodiment. In addition, FIG. 5 shows, for example, a case where foreign matter is present on the upper surface of the first load section S1 and thus the object P is placed to be tilted with respect to the upper surface of the first load section S1.

As shown in FIG. 4, the controller 15 first operates the robot arm 12, thereby moving the suction unit 22 toward the object P (Step S11). Then, the controller 15 reduces the stiffness of the joint 23 by reducing the retention force of the actuator 24 before the suction unit 22 comes into contact with the object P (Step S12). That is, the controller 15 changes the joint 23 to the first state.

After the joint 23 has entered the first state, the controller 15 moves the suction unit 22 toward the object P and presses the suction unit 22 against the object P. If the suction unit 22 is pressed against the object P, as shown in (a) and (b) of FIG. 5, the posture of the suction unit 22 passively changes due to a reaction force that the suction unit 22 receives from the object P. That is, the holding surface 22a of the suction unit 22 is tilted in accordance with the outer shape of the object P. In this way, the holding surface 22a of the suction unit 22 comes into contact with the object P along the inclined surface of the object P.

As shown in FIG. 4, the controller 15 causes the suction unit 22 to hold the object P by a suction operation of the suction unit 22 in a state where the suction unit 22 is in contact with the object P (Step S13). In this embodiment, the holding surface 22a of the suction unit 22 is inclined along the surface of the object P, and therefore, the suction unit 22 can reliably hold the object P. In other words, the controller 15 causes the suction unit 22 to move toward the object P and to catch the object P while maintaining the first state of the joint 23. Then, the controller 15 increases the stiffness of the joint 23 by increasing the retention force of the actuator 24 in a state where the suction unit 22 has held the object P (Step S14). That is, the controller 15 changes the joint 23 from the first state to the second state. In this way, the stiffness of the joint 23 is increased in a state where the suction unit 22 is tilted in accordance with the outer shape of the object P. For this reason, the posture of the suction unit 22 is fixed in a state where the suction unit 22 is tilted. Further, for example, if it is a state where the suction unit 22 is in contact with the object P, an operation of increasing the stiffness of the joint 23 may be performed before the suction unit 22 suctions the object P or may be performed at the same as an operation in which the suction unit 22 suctions the object P.

Then, the controller 15 transports the object P held by the suction unit 22, by operating the robot arm 12 after the posture of the suction unit 22 is fixed (Step S15). That is, the suction unit 22 transports the object P in a state where the suction unit 22 is tilted in accordance with the outer shape of the object P, as shown in (c) of FIG. 5. Then, as shown in FIG. 4, the controller 15 releases the holding of the suction unit 22 with respect to the object P at a destination of conveyance (Step S16). In this way, the conveyance of the object P by the suction unit 22 is completed. In other words, the controller 15 causes the suction unit 22 to transport the object P while maintaining the second state of the joint 23.

In the control operation of the controller 15 described above, the operation of the transporter 1 has been described by taking a case where the object P is placed to be tilted. There is no limitation thereto, and for example, also with respect to the object P having an inclined surface as a part of the outer surface, the object P having a concavo-convex shape at the surface, or the like, the suction unit 22 of the transporter 1 of this embodiment can be tilted in accordance with the outer shape of the object P. In this way, the transporter 1 of this embodiment can reliably holds and transports the objects P having various shapes.

According to the transporter 1 and the transport method having such a configuration, it is possible to attain a reduction in the size of the transporter 1.

Here, there is a case where an object as a conveyance target of a transporter is placed to be tilted due to foreign matter, as described above, or the object itself has an inclined surface, a concavo-convex shape, or the like. For this reason, there is a case where a transporter for transporting the object includes an end effector having a complicated mechanism, a large robot arm, or the like in order to cope with objects having various states or shapes. However, in a case of including the end effector having a complicated mechanism, or the large robot arm, the transporter is prone to become larger.

On the other hand, the transporter 1 of this embodiment includes the suction unit 22, the joint 23, the actuator 24, and the controller 15. The suction unit 22 holds the object P. The joint 23 supports the suction unit 22 and allows a change in posture of the suction unit 22. The actuator 24 can output a force suppressing the movement of the joint 23. The controller 15 changes the stiffness of the joint 23 by controlling an amount of the force that the actuator 24 outputs.

According to such a configuration, the transporter 1 can press the suction unit 22 against the object P, for example, in a state where the stiffness of the joint 23 is reduced. In this way, the suction unit 22 is passively tilted in accordance with the outer shape of the object P, thereby being able to reliably hold the object P. For this reason, the transporter 1 can hold objects having various state or shapes, with a relatively simple configuration. In this way, it is possible to attain a reduction in the size of the transporter 1.

Further, from a different point of view, the transporter 1 of this embodiment includes the actuator 24 which can output an adjustment force adjusting the posture of the suction unit 22. The controller 15 controls an amount of the adjustment force that the actuator 24 outputs.

According to such a configuration, for example, by causing the amount of the adjustment force to be smaller than a reaction force from the object P, it is possible to passively tilt the suction unit 22 in accordance with the outer shape of the object P. For this reason, the transporter 1 can hold objects having various state or shapes, with a relatively simple configuration. In this way, it is possible to attain a reduction in the size of the transporter 1.

In this embodiment, the controller 15 causes the joint 23 to have a first stiffness in a case where the suction unit 22 is not holding the object P, and causes the joint 23 to have a second stiffness in a case where the suction unit 22 is holding the object P. The first stiffness is smaller than the second stiffness. For example, the controller 15 causes the stiffness of the joint 23 to be smaller in a case where the suction unit 22 approaches the object P and catches the object P, than the stiffness of the joint 23 in a case where the suction unit 22 has held and transports the object P.

According to such a configuration, it is possible to press the suction unit 22 against the object P in a state where the stiffness of the joint 23 is reduced. Further, during the conveyance of the object P, the stiffness of the joint 23 is increased, whereby vibration or the like does not easily occur in the object P, and thus it is possible to stably convey the object P.

In this embodiment, the actuator 24 includes at least one pneumatic actuator 40A. The controller 15 controls pressure which is supplied to the pneumatic actuator 40A, thereby controlling an amount of a force that the actuator 24 outputs.

According to such a configuration, it is possible to relatively easily control the amount of the force that the actuator 24 outputs. In this way, it is possible to further simplify the structure of the transporter 1.

In this way, it is possible to attain a further reduction in the size of the transporter 1.

In this embodiment, each of the pneumatic actuators 40A and 40B is a double-acting cylinder which includes the first chamber 44a and the second chamber 44b. Substantially the same pressure is supplied to the first chamber 44a and the second chamber 44b, whereby each of the pneumatic actuators 40A and 40B outputs a force suppressing the movement of the joint 23. That is, the pneumatic actuators 40A and 40B generate the above-described retention forces by causing the pressure in the first chamber 44a and the pressure in the second chamber 44b to be balance with each other. Further, each of the pneumatic actuators 40A and 40B changes the amount of the force suppressing the movement of the joint 23, by changing the first pressure which is supplied to the first chamber 44a and the second pressure which is supplied to the second chamber 44b by approximately the same amount.

According to such a configuration, it is possible to finely control the amount of the force suppressing the movement of the joint 23, with a relatively simple configuration.

In this embodiment, the joint 23 includes the goniometer guide 30 having, the sliding surfaces 31a and 32a formed in curved shape. The suction unit 22 can change the posture along the sliding surfaces 31a and 32a of the goniometer guide 30.

According to such a configuration, it is possible to make the configuration of the joint 23 simple, compared to, for example, sixth and seventh embodiments described later. Further, according to the configuration of this embodiment, it is possible to reduce the number of pneumatic actuators, compared to the sixth and seventh embodiments. In this way, it is possible to attain a reduction in the manufacturing cost of the transporter 1.

In this embodiment, the transporter 1 includes the suction unit 22 which suctions the object P.

According to such a configuration, it is possible to hold the object P by suctioning the object P, and therefore, it can be said that it is easier to cope with the objects P having various states or shapes.

Further, in the transport method of this embodiment, the transporter 1 holds the object P by the suction unit 22 by moving the suction unit 22 close to the object P with the joint 23 being in the first state of allowing a change in posture of the suction unit 22. Then, the transporter 1 transports the object P with the joint 23 being in the second state where the stiffness is larger than that in the first state.

According to such a configuration, at the time of the holding of the object P, by reducing the stiffness of the joint 23, it is possible to reliably hold the object P. For this reason, the transporter 1 can cope with the objects P having various states or shapes with a relatively simple configuration. In this way, it is possible to attain a reduction in the size of the transporter 1. Further, according to the above configuration, at the time of the conveyance of the object P, by increasing the stiffness of the joint 23, it is possible to stably convey the object P.

### Second Embodiment

Next, a second embodiment will be described.

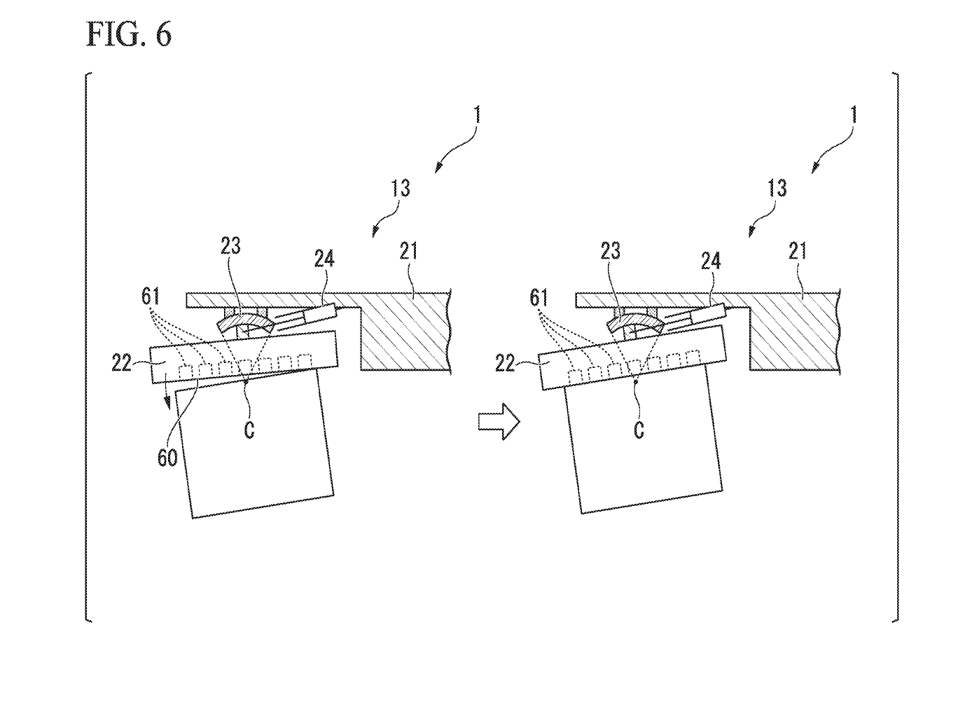

FIG. 6 shows the transporter 1 of the second embodiment. This embodiment is different from the first embodiment in that in this embodiment, in a case where a portion of the suction unit 22 does not hold the object P, the suction unit 22 is actively operated. Other configurations of this embodiment are the same as or similar to those of the first embodiment.

As shown in FIG. 6, the transporter 1 of this embodiment includes a detector (e.g., a holding error location detector) 61 that detects a non-holding portion 60 of the suction unit 22, which does not hold the object. The detector 61 detects, for example, the presence or absence of the non-holding portion 60 and the position of the non-holding portion 60 in a state where the suction unit 22 holds the object P. An example of the detector 61 is a pressure sensor that detects the pressure state of each suction hole 22b (refer to FIG. 2) of the suction unit 22. That is, the detector 61 detects the pressure state of each suction hole 22b, thereby detecting whether or not the surroundings of each suction hole 22b is in contact with the object P. Instead of this, a distance sensor that measures the distance between the suction unit 22 and the object P, or the like is also acceptable as the detector 61.

In this embodiment, the joint position controller 51 changes the posture of the suction unit 22 in a direction causing the non-holding portion 60 of the suction unit 22 to come close to the object P, based on the detection result of the detector 61. For example, as shown in FIG. 6, the joint position controller 51 drives the actuator 24, thereby rotating the suction unit 22 with the rotation center C as the center of rotation, in the direction bringing the non-holding portion 60 close to the object P.

Next, the flow of a control operation of this embodiment will be described.

The control operation of this embodiment is the same as that of the first embodiment to the point where the suction unit 22 holds the object P. In this embodiment, after the suction unit 22 holds and lifts the object P, the presence or absence of the non-holding portion 60 is detected by the detector 61. In a case where the presence of the non-holding portion 60 is not detected, the transporter 1 directly proceeds to the transport of the object P. On the other hand, in a case where the presence of the non-holding portion 60 has been detected, the controller 15 drives the actuator 24, thereby outputting the adjustment force, and rotates the suction unit 22 such that the non-holding portion 60 comes into contact with the object P. In this way, the non-holding portion 60 comes into contact with the object P, and thus the area holding the object P is increased. Then, the controller 15 increases the area holding the object P and then proceeds to the transport of the object P. Instead of the above, the operation of detecting the non-holding portion 60 by the detector 61 and the operation of rotating the suction unit 22 such that the non-holding portion 60 comes into contact with the object P may be performed in the middle of the suction unit 22 holding and lifting the object P or may be performed at a timing when the suction unit 22 catches the object P.

According to the transporter 1 and the transport method having such a configuration, similar to the first embodiment described above, it is possible to attain a reduction in the size of the transporter 1.

Further, in this embodiment, the controller 15 drives the actuator 24 such that the non-holding portion 60 comes close to the object P, based on the detection result of the detector 61.

According to such a configuration, by actively adjusting the posture of the suction unit 22, it is possible to increase the suction area (i.e., the holding area) of the suction unit 22 with respect to the object P. In this way, it is possible to more stably convey the object P.

### Third Embodiment

Next, a third embodiment will be described.

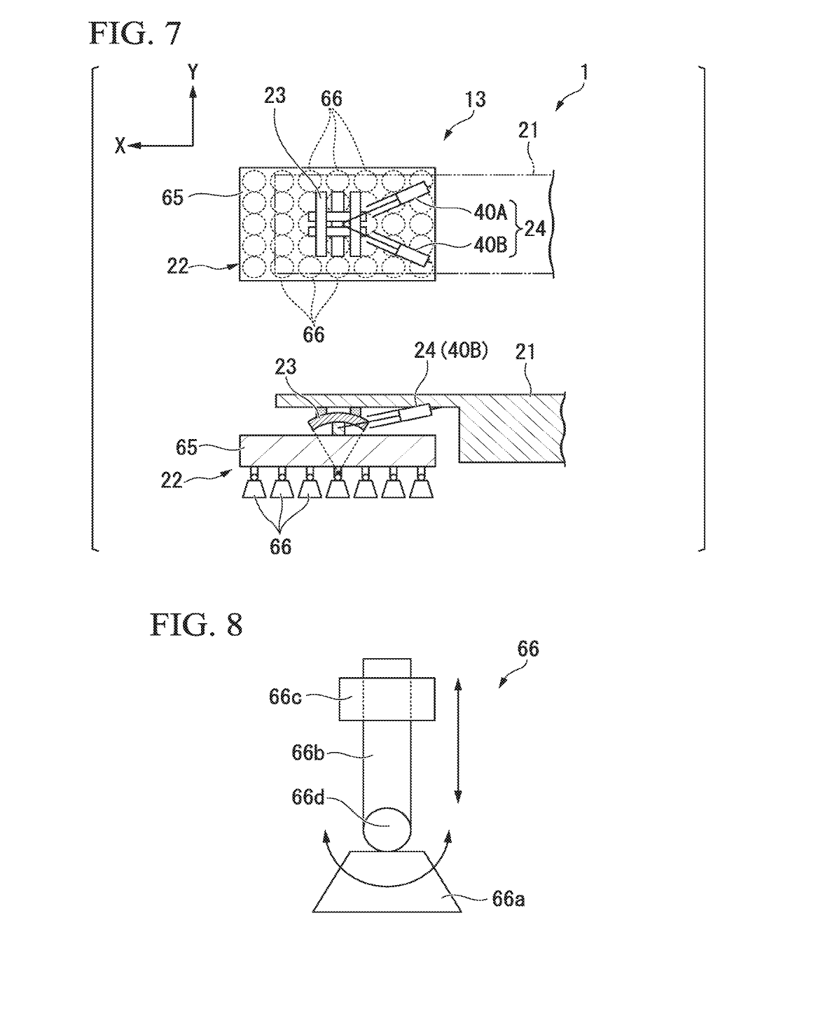

FIGS. 7 to 9 show the transporter 1 of the third embodiment. This embodiment is different from the first embodiment in that in this embodiment, the suction unit 22 includes a plurality of suction pad units 66. Other configurations of this embodiment are the same as or similar to those of the first embodiment.

FIG. 7 shows the transporter 1 of this embodiment.

As shown in FIG. 7, the suction unit 22 of this embodiment includes a unit frame 65 and the plurality of suction pad units 66.

The unit frame 65 is an example of a “base”. The unit frame 65 is connected to the joint 23 and supported by the joint 23. For this reason, the unit frame 65 can change the posture thereof with respect to the robot arm 12. Further, the unit frame 65 is connected to the actuator 24. That is, the posture of the unit frame 65 can be controlled by driving the actuator 24.

The plurality of suction pad units 66 are an example of a “suction mechanism” which suctions and holds the object P. The plurality of suction pad units 66 are attached to the unit frame 65 and supported by the unit frame 65. For example, the plurality of suction pad units 66 are arranged along the X-direction and the Y-direction on one surface of the unit frame 65.

FIG. 8 is a side view schematically showing each suction pad unit 66.

As shown in FIG. 8, each suction pad unit 66 includes a suction pad 66a, a slider 66b, a suction pad mounting section 66c, and a spherical joint 66d.

The suction pad 66a is an example of a “suction part”. For example, the suction pad 66a includes a suction hole which is subjected to vacuum suction by a tube and a pump (none of which is shown). The suction pad 66a suctions and holds the object P.

The slider 66b is an example of a “movable part” and is an example of a “passive linear motion mechanism”. The slider 66b is movably supported by the suction pad mounting section 66c. The suction pad mounting section 66c is fixed to the unit frame 65 (refer to FIG. 7). For this reason, the slider 66b is supported by the unit frame 65 with the suction pad mounting section 66c therebetween. The slider 66b is movable with respect to the unit frame 65 along a direction (e.g., the Z-direction) toward the unit frame 65 from the object P. The slider 66b is biased away from the unit frame 65 by an elastic member such as a spring, for example.

The spherical joint 66d is an example of a “joint part” and is an example of a “passive rotary joint”. The spherical joint 66d is provided between an end portion on the protrusion side of the slider 66b and the suction pad 66a. The spherical joint 66d rotatably connects the suction pad 66a and the slider 66b. In this way, the suction pad 66a can be tilted in any direction with respect to the slider 66b in a case where an external force acts thereon.

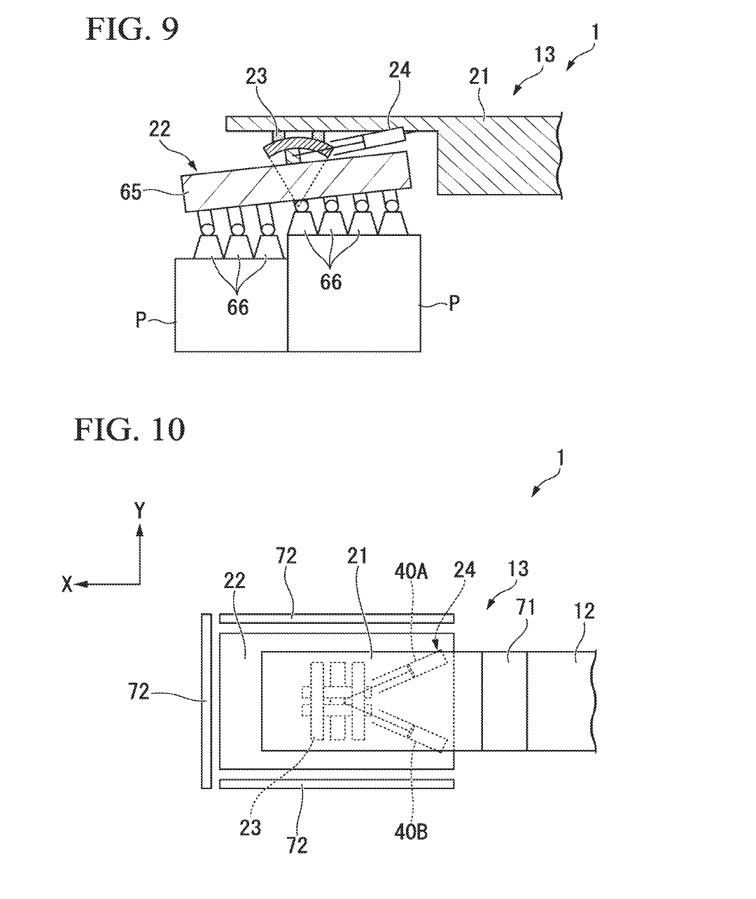

FIG. 9 shows a usage example of the transporter 1 of this embodiment.

As shown in FIG. 9, the suction unit 22 of this embodiment is pressed against a plurality of objects P having, for example, different heights, in a state where the stiffness of the joint 23 is reduced. In this case, the unit frame 65 of the suction unit 22 changes in posture so as to fit the heights of the plurality of objects P and is tilted with respect to the plurality of objects P. Further, the slider 66b passively retracts into the unit frame 65 according to the size of the gap between the unit frame 65 and the object P. In this way, the plurality of suction pads 66a can be arranged on the surface of the object P.

Further, the slider 66b is tiled along with the unit frame 65 with respect to the object P. However, the suction pad 66a is supported by the spherical joint 66d, thereby passively rotating so as to follow the surface of the object P. In this way, the plurality of suction pads 66a are pressed against the surfaces of the objects P in a substantially parallel fashion.

According to the transporter 1 having such a configuration, similar to the first embodiment described above, it is possible to attain a reduction in the size of the transporter 1.

Further, in this embodiment, the suction unit 22 includes the unit frame 65 supported by the joint 23, and the plurality of suction pad units 66 attached to the unit frame 65. Each suction pad unit 66 includes the suction pad 66a, the slider 66b, and the spherical joint 66d. The suction pad 66a suctions the object P. The slider 66b is supported by the unit frame 65 and is movable along the direction toward the unit frame 65 from the object P. The spherical joint 66d rotatably connects the suction pad 66a and the slider 66b.

According to such a configuration, the suction pads 66a can be pressed against the plurality of objects P having different heights, in a parallel fashion. In this way, it is possible to reliably hold the objects P. Further, according to the above configuration, even in a case where the object P has a concavo-convex shape, or the like, it is possible to reliably hold the object P.

### Fourth Embodiment

Next, a fourth embodiment will be described.

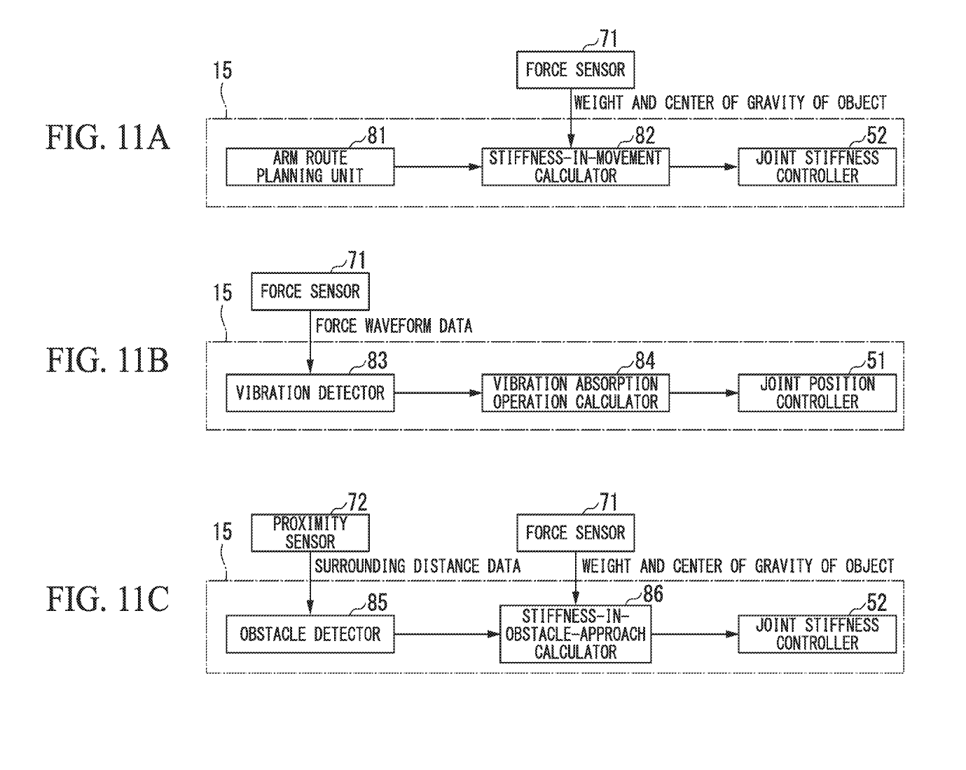

FIGS. 10, 11A, 11B, and 11C show the transporter 1 of the fourth embodiment. This embodiment is different from the first embodiment in that in this embodiment, the stiffness of the joint 23 is changed based on the detection result of a force sensor 71 or the like. Other configurations of this embodiment are the same as or similar to those of the first embodiment.

FIG. 10 shows the transporter 1 of this embodiment.

As shown in FIG. 10, the transporter 1 includes the force sensor 71 and a proximity sensor 72.

The force sensor 71 detects a force which acts on the end effector 13 (e.g., a force which acts on the suction unit 22). The force sensor 71 is provided, for example, between the robot arm 12 and the frame 21. The force sensor 71 is, for example, a 6-axis force sensor. That is, the force sensor 71 detects forces in the X-direction, the Y-direction, and the Z-direction, which act on the frame 21. Further, the force sensor 71 detects a moment around an X-axis, a moment around a Y-axis, and a moment around a Z-axis, which act on the frame 21. The X-axis, the Y-axis, and the Z-axis respectively are virtual axes along the X-direction, the Y-direction, and the Z-direction. The controller 15 of this embodiment calculates the weight and the center of gravity of the object P that the suction unit 22 holds, based on the detection result of the force sensor 71.

The proximity sensor 72 is an example of an “obstacle sensor”. The proximity sensor 72 is disposed around the suction unit 22 and detects an object which is located around the suction unit 22. The proximity sensor 72 is, for example, a distance sensor and detects an object which is located around the suction unit 22, in a contactless manner. Instead of this, the “obstacle sensor” may be a contact-type sensor.

FIGS. 11A, 11B, and 11C are block diagrams showing system configurations of the controller 15 of this embodiment.

As shown in FIGS. 11A, 11B, and 11 C, the controller 15 of this embodiment has a function of performing the following three controls.

First, as shown in FIG. 11A, the controller 15 of this embodiment controls the stiffness of the joint 23, based on a movement speed of the frame 21, or the weight of the object P or the like. For example, the controller 15 includes an arm route planning unit 81, a stiffness-in-movement calculator 82, and the joint stiffness controller 52.

The arm route planning unit 81 generates a movement plan of the robot arm 12 (i.e., a movement plan of the frame 21), based on information related to a location of a movement origin of the object P, information related to a location of a movement destination of the object P, or the like. The movement plan includes information related to a movement of the frame 21. The information related to the movement of the frame 21 includes, for example, information related a movement path of the frame 21, and information related to a movement speed and an acceleration of the frame 21.

The stiffness-in-movement calculator 82 receives the information related to the movement of the frame 21 from the arm route planning unit 81. Further, the stiffness-in-movement calculator 82 receives the information related to the weight of the object P and the center of gravity of the object P which are calculated from the detection result of the force sensor 71. Then, the stiffness-in-movement calculator 82 calculates the magnitude of stiffness which is set in the joint 23 at the time of the conveyance of the object P, based on the information related to the movement of the frame 21 (e.g., the information related to the movement speed of the frame 21), and the information related to the weight of the object P and the center of gravity of the object P. For example, the stiffness-in-movement calculator 82 calculates the value of stiffness which is larger as a movement speed of the frame 21 is high speed. Further, the stiffness-in-movement calculator 82 calculates the value of stiffness which is larger as the object P is heavier. Further, the stiffness-in-movement calculator 82 calculates the value of stiffness which is larger as the center of gravity of the object P is deviated from the center of the suction unit 22. Further, the stiffness-in-movement calculator 82 need not calculate stiffness, based on all the above information, and may calculate the value of the stiffness, based on at least one of for example, the information related to the movement of the frame 21, the information related to the weight of the object P, and the information related to the center of gravity of the object P.

The joint stiffness controller 52 controls the stiffness of the joint 23, based on the value calculated by the stiffness-in-movement calculator 82. That is, the joint stiffness controller 52 increases the retention force of the actuator 24 as the value calculated by the stiffness-in-movement calculator 82 is larger.

Next, as shown in FIG. 11B, the controller 15 of this embodiment performs a vibration absorption operation which damps vibration of the object P at the time of deceleration or the time of stop of the object P which is being conveyed. For example, the controller 15 of this embodiment includes a vibration detector 83, a vibration absorption operation calculator 84, and the joint position controller 51.

The vibration detector 83 receives the detection result of the force sensor 71. For example, the vibration detector 83 receives force waveform data acting on the end effector 13 (e.g., the suction unit 22), from the force sensor 71. The vibration detector 83 detects vibration of the end effector 13 (e.g., the suction unit 22), based on the detection result of the force sensor 71.

The vibration absorption operation calculator 84 calculates a vibration absorption operation of damping vibration of the suction unit 22, based on information related to vibration (e.g., at least one of the magnitude and period of vibration) detected by the vibration detector 83. For example, the vibration absorption operation calculator 84 calculates, as an example of the vibration absorption operation, an operation of applying a force in the opposite direction to the direction in which the suction unit 22 moves due to vibration, to the suction unit 22 by the actuator 24.

The joint position controller 51 drives the actuator 24, based on the vibration absorption operation calculated by the vibration absorption operation calculator 84. That is, the joint position controller 51 actively drives the actuator 24 so as to damp the vibration of the suction unit 22.

Further, as shown in FIG. 11C, the controller 15 of this embodiment performs an operation of reducing the stiffness of the joint 23 in a case where an obstacle is present in the vicinity of the suction unit 22. For example, the controller 15 of this embodiment includes an obstacle detector 85, a stiffness-in-obstacle-approach calculator 86, and the joint stiffness controller 52.

The obstacle detector 85 receives the detection result from the proximity sensor 72. For example, the obstacle detector 85 receives data related to a distance to an obstacle from the proximity sensor 72. The obstacle detector 85 detects the presence of an obstacle within a distance set in advance as seen from the suction unit 22, based on the detection result of the proximity sensor 72.

The stiffness-in-obstacle-approach calculator 86 receives information related to an obstacle at least one of the position of an obstacle and a distance to an obstacle) from the obstacle detector 85. Further, the stiffness-in-obstacle-approach calculator 86 receives information related to at least one of the weight of the object P and the center of gravity of the object P which are calculated from the detection result of the force sensor 71. The stiffness-in-obstacle-approach calculator 86 calculates the amount of stiffness which is set in the joint 23, based on information related to an obstacle, and information related to at least one of the weight of the object P and the center of gravity of the object P. For example, the stiffness-in-obstacle-approach calculator 86 calculates the value of stiffness which is smaller as an obstacle is closer. Further, the stiffness-in-obstacle-approach calculator 86 calculates the value of stiffness which is smaller as the object P is lighter. Further, the stiffness-in-obstacle-approach calculator 86 calculates the value of stiffness which is smaller as the center of gravity of the object P is closer to the center of the suction unit 22. Further, the stiffness-in-obstacle-approach calculator 86 need not calculate stiffness, based on all the information, and may calculate the value of the stiffness, based on at least one of, for example, the information related to the distance to an obstacle, the information related to the weight of the object P, and the information related to the center of gravity of the object P.

The joint stiffness controller 52 controls the stiffness of the joint 23 based on the value calculated by the stiffness-in-obstacle-approach calculator 86. That is, the joint stiffness controller 52 reduces the retention force of the actuator 24 as the value calculated by the stiffness-in-obstacle-approach calculator 86 is smaller.

According to the transporter 1 and the transport method having such a configuration, similar to the first embodiment described above, it is possible to attain a reduction in the size of the transporter 1.

Here, if the stiffness of the joint 23 is small during the conveyance of the object P, there is a case where the conveyance of the object P becomes unstable. On the other hand, if the stiffness of the joint 23 during the conveyance of the object P is made to be always large, energy required to drive the actuator 24 is increased. Therefore, in this embodiment, the controller 15 changes the stiffness of the joint 23, based on the detection result from the force sensor 71. In this way, improvement in stability of conveyance of the object P and a reduction in energy consumption of the transporter 1 can be realized in a well-balanced manner.

For example, in a case where the robot arm 12 moves at high speed, if the stiffness of the joint 23 is small, there is a case where the object P vibrates. Therefore, in this embodiment, the controller 15 changes the stiffness of the joint 23, based on information which is obtained from the movement plan of the robot arm 12. In this way, it is possible to enhance the stability of conveyance of the object P.

Further, in a case where the object P is heavy, or a case where the center of gravity of the object P is deviated from the center of the suction unit 22, if the stiffness of the joint 23 is small, there is a possibility that the conveyance of the object P may become unstable. Therefore, in this embodiment, the controller 15 changes the stiffness of the joint 23, based on information related to at least one of the weight of the object P and the center of gravity of the object P which are obtained from the detection result of the force sensor 71. That is, the stiffness of the joint 23 in the second state is controlled based on information related to at least one of the weight of the object P and the center of gravity of the object P. In this way, it is possible to enhance the stability of conveyance of the object P.

Further, with the object P, there is a case where vibration based on, for example, an inertial force of the object P occurs, for example, at the time of deceleration or the time of sop of the object P which is being carried. Therefore, in this embodiment, the controller 15 controls the actuator 24 so as to reduce the vibration, based on information related to the vibration of the object P which is obtained from the detection result of the force sensor 71. According to such a configuration, it is not necessary to make the transporter 1 sturdy in advance in order to suppress the vibration of the object P. For this reason, according to the above configuration, it is possible to further attain a reduction in the size and a reduction in the weight of the transporter 1.

For example, in a case where the suction unit 22 or the object P comes into contact with an obstacle, there is a case where the suction unit 22 or the object P is damaged. Therefore, in this embodiment, the controller 15 changes the stiffness of the joint 23, based on information which is obtained from the detection result of the proximity sensor 72. For example, the controller 15 reduces the stiffness of the joint 23 in a case where there is a possibility that the suction unit 22 or the object P may come into contact with an obstacle. In this way, even in a case where the suction unit 22 or the object P comes into contact with an obstacle, the suction unit 22 and the object P rotate around the joint 23, whereby it is possible to reduce the influence of an impact due to the contact. In this way, it is possible to suppress damage to the suction unit 22 and the object P.

### Fifth Embodiment

Next, a fifth embodiment will be described.

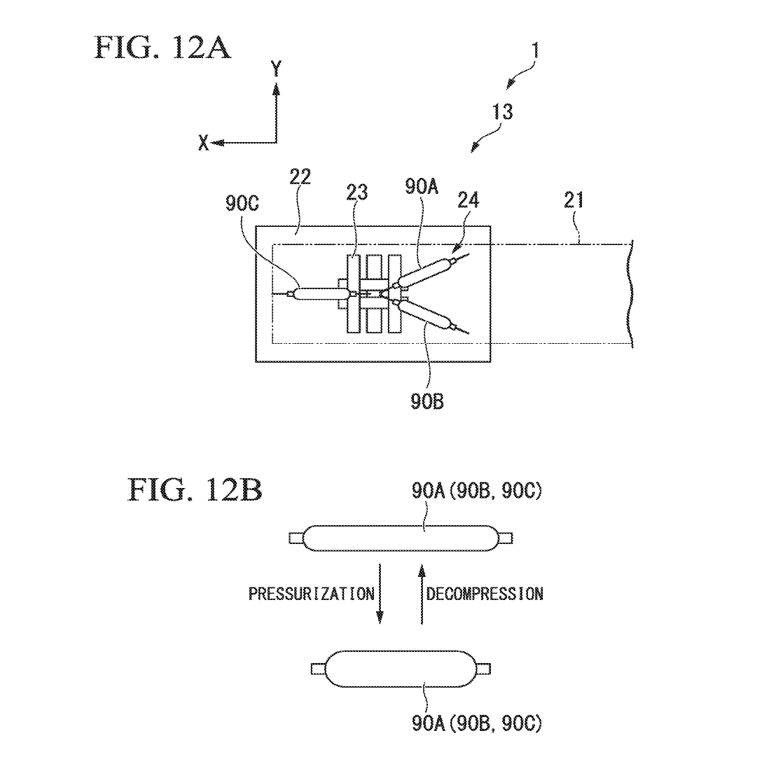

FIGS. 12A and 12B show the transporter 1 of the fifth embodiment. This embodiment is different from the first embodiment in that in this embodiment, as the pneumatic actuator, a pneumatic artificial muscle actuator is used instead of the double-acting cylinder. Other configurations of this embodiment are the same as or similar to those of the first embodiment.

As shown in FIG. 12A, the actuator 24 of the transporter 1 of this embodiment includes a plurality of (e.g., three) pneumatic artificial muscle actuators 90A, 90B, and 90C. As shown in FIG. 12B, each of the pneumatic artificial muscle actuators 90A, 90B, and 90C becomes an extended state in a decompression state, and generates a force in a shrinking direction in a pressurization state, for example. Each of the pneumatic artificial muscle actuators 90A, 90B, and 90C is connected to the frame 21 and the suction unit 22.

In this embodiment, the pneumatic artificial muscle actuators 90A and 90B and the pneumatic artificial muscle actuator 90C are disposed to be separated on both sides of the joint 23 in the X-direction. Further, the two pneumatic artificial muscle actuators 90A and 90B are disposed to be separated on both sides of the joint 23 in the Y-direction. The two pneumatic artificial muscle actuators 90A and 90B are provided along the directions different from each other with respect to the joint 23. With this configuration, the suction unit 22 can perform a rotational motion having two degrees of freedom with the above-described rotation center C (refer to FIG. 2) as the center of rotation by the driving of the pneumatic artificial muscle actuators 90A, 90B, and 90C. Further, the plurality of pneumatic artificial muscle actuators 90A, 90B, and 90C are supplied with pressure, thereby outputting forces suppressing the movement (e.g., rotation) of the joint 23 between the suction unit 22 and the frame 21.

The controller 15 of this embodiment controls pressure which is supplied to the pneumatic artificial muscle actuators 90A, 90B, and 90C, thereby controlling the amount of the force suppressing the movement of the joint 23. For example, the controller 15 increases the pressure in each of the plurality of pneumatic artificial muscle actuators 90A, 90B, and 90C which are located on both sides of the joint 23, thereby increasing the force suppressing the movement of the joint 23. In this way, the stiffness of the joint 23 is increased. Further, the controller 1.5 reduces the pressure in each of the plurality of pneumatic artificial muscle actuators 90A, 90B, and 90C which are located on both sides of the joint 23, thereby reducing the force suppressing the movement of the joint 23. In this way, the stiffness of the joint 23 is reduced.

According to the transporter 1 having such a configuration, similar to the first embodiment described above, it is possible to attain a reduction in the size of the transporter 1.

Further, in this embodiment, the actuator 24 includes the pneumatic artificial muscle actuators 90A, 90B, and 90C. Here, in general, the pneumatic artificial muscle actuator can provide a force larger than that in a double-acting cylinder. Further, in general, the pneumatic artificial muscle actuator is lighter than a double-acting cylinder. For this reason, if the actuator 24 includes the pneumatic artificial muscle actuators 90A, 90B, and 90C, it is possible to attain a reduction in the weight of the transporter 1 while providing high stiffness to the joint 23.

### Sixth Embodiment

Next, a sixth embodiment will be described.

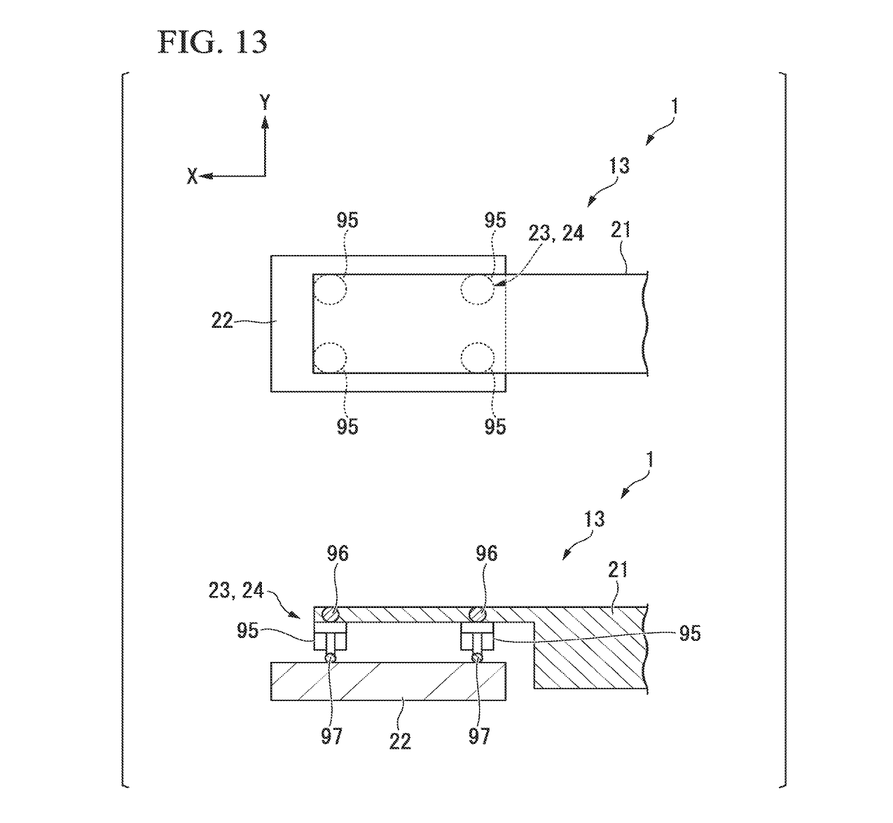

FIG. 13 shows the transporter 1 of the sixth embodiment. This embodiment is different from the first embodiment in that in this embodiment, the suction unit 22 and the frame 21 are connected by a pneumatic actuator 95. Other configurations of this embodiment are the same as or similar to those of the first embodiment.

As shown in FIG. 13, the actuator 24 of this embodiment includes a plurality of (e.g., four) pneumatic actuators 95. The plurality of pneumatic actuators 95 are disposed in parallel with respect to the suction unit 22. That is, each of the plurality of pneumatic actuators 95 is connected to the suction unit 22 and the frame 21. For example, the plurality of pneumatic actuators 95 are disposed at positions separated from each other in the X-direction and the Y-direction.

Each pneumatic actuator 95 is, for example, a double-acting cylinder as shown in FIG. 3. The plurality of pneumatic actuators 95 can be individually controlled in length and pressure (e.g., the above-described retention force). By controlling the length of each pneumatic actuator 95, it is possible to control the posture of the suction unit 22 with respect to the robot arm 12. Further, by controlling the retention force of each pneumatic actuator 95, it is possible to control the stiffness of the joint 23.

A first spherical joint 96 is provided between each pneumatic actuator 95 and the frame 21. The first spherical joint 96 rotatably connects each pneumatic actuator 95 to the frame 21. On the other hand, a second spherical joint 97 is provided between each pneumatic actuator 95 and the suction unit 22. The second spherical joint 97 rotatably connects each pneumatic actuator 95 and the suction unit 22. In this way, each pneumatic actuator 95 can be tilted in any direction with respect to the frame 21 and the suction unit 22. In this embodiment, the joint 23 is formed by the plurality of pneumatic actuators 95 and the spherical joints 96 and 97.

According to the transporter 1 having such a configuration, similar to the first embodiment described above, it is possible to attain a reduction in the size of the transporter 1.

Further, in this embodiment, the actuator 24 includes the plurality of pneumatic actuators 95 which are disposed in parallel with respect to the suction unit 22 and individually drive from each other.

According to such a configuration, it is possible to form the joint 23 by the plurality of pneumatic actuators 95. In other words, it is possible to form the joint 23 without a goniometer guide. In this way, it is possible to attain a reduction in the weight of the transporter 1.

### Seventh Embodiment

Next, a seventh embodiment will be described.

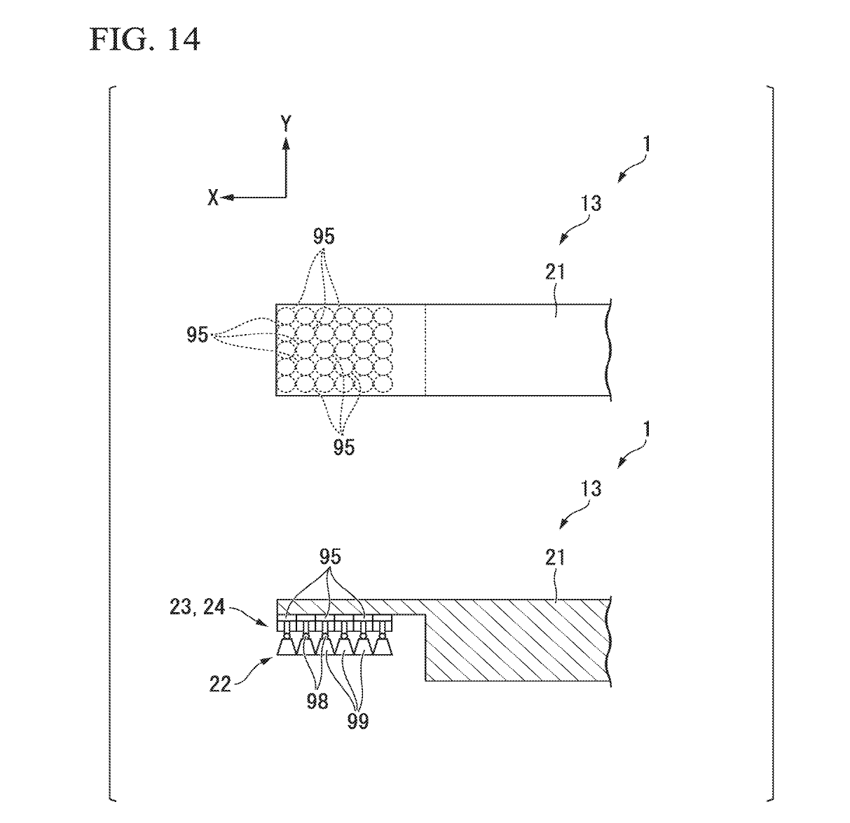

FIG. 14 shows the transporter 1 of the seventh embodiment. This embodiment is different from the first embodiment in that in this embodiment, the joint 23 and the suction unit 22 are formed by the plurality of pneumatic actuators 95 and a plurality of suction pads 99. Other configurations of this embodiment are the same as or similar to those of the first embodiment.

As shown in FIG. 14, the actuator 24 of this embodiment includes the plurality of pneumatic actuators 95. The plurality of pneumatic actuators 95 are mounted in parallel on the frame 21. In this embodiment, for example, three or more pneumatic actuators 95 are disposed in the X-direction. Further, three or more pneumatic actuators 95 are disposed in the Y-direction.

Each pneumatic actuator 95 is, for example, a double-acting cylinder as shown in FIG. 3. The plurality of pneumatic actuators 95 individually drives from each other. That is, the plurality of pneumatic actuators 95 can be individually controlled in length and pressure (e.g., the above-described retention force). By controlling the length of each pneumatic actuator 95, it is possible to control the posture of the suction unit 22 with respect to the robot arm 12. Further, by controlling the retention force of each pneumatic actuator 95, it is possible to control the stiffness of the joint 23. In this embodiment, the joint 23 is formed by the plurality of pneumatic actuators 95.

The suction pad 99 is mounted on an end of the pneumatic actuator 95 with a spherical joint 98 therebetween. The suction pad 99 suctions and holds the object P. For example, the suction pad 99 includes a suction hole which is subjected to vacuum suction by a tube and a pump (none of which is shown). The spherical joint 98 rotatably connects the suction pad 99 and the tip of the rod 43.

In this way, the suction pad 99 can be tilted in any direction with respect to the pneumatic actuator 95. In this embodiment, the suction unit 22 is formed by the plurality of suction pads 99.

According to the transporter 1 having such a configuration, similar to the first embodiment described above, it is possible to attain a reduction in the size of the transporter 1.

Further, in this embodiment, the joint 23 and the suction unit 22 are formed by the plurality of pneumatic actuators 95 and the plurality of suction pads 99. According to such a configuration, similar to the sixth embodiment described above, it is possible to form the joint 23 without a goniometer guide. In this way, it is possible to attain a reduction in the weight of the transporter 1. Further, according to the above configuration, the plurality of suction pads 99 in which positions can be individually controlled by the pneumatic actuators 95 are provided, and therefore, the suction unit 22 can appropriately cope with even the object P having a more complex concavo-convex shape, a plurality of objects P having different heights, or the like.

The first to seventh embodiments have been described above. However, the configurations of the embodiments are not limited to the above examples. For example, in the embodiments described above, the transporter 1 in which the suction unit 22 can be tilted in a plurality of directions (e.g., the X-direction and the Y-direction) has been described. However, the transporter 1 may have a configuration in which the suction unit 22 is tilted in only one direction (e.g., only the X-direction or only the Y-direction).

According to at least one of the embodiments described above, the transporter includes a holder, a joint, an actuator, and a controller. The joint allows a change in posture of the holder. The actuator can output a force suppressing the movement of the joint. The controller changes the stiffness of the joint by controlling the amount of the force. According to such a configuration, it is possible to attain a reduction in the size of the transporter.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A transporter comprising:
a holder configured to hold an object;
a joint configured to support the holder and to allow a change in posture of the holder;
an actuator configured to output a force suppressing a movement of the joint; and
a controller configured to change stiffness of the joint by controlling an amount of the force.

2. The transporter according to claim 1, wherein
the controller causes the joint to have a first stiffness in a case where the holder is not holding the object, and causes the joint to have a second stiffness in a case where the holder is holding the object, the first stiffness being smaller than the second stiffness.

3. The transporter according to claim 1, further comprising:
a detector configured to detect a non-holding portion of the holder, the non-holding portion being a portion which does not hold the object,
wherein
the actuator is configured to drive the joint, and
the controller is configured to control the actuator to cause the non-holding portion to come close to the object, based on a detection result from the detector.

4. The transporter according to claim 1, wherein
the actuator comprises at least a pneumatic actuator, and
the controller is configured to control the amount of the force by controlling pressure which is supplied to the pneumatic actuator.

5. The transporter according to claim 4, wherein
the pneumatic actuator is a double-acting cylinder comprising a first chamber and a second chamber, the pneumatic actuator is configured to output the force suppressing the movement of the joint by substantially the same pressure being supplied to the first chamber and the second chamber, and the pneumatic actuator is configured to change the amount of the force by the controller changing first pressure and second pressure by substantially the same amount, the first pressure is supplied to the first chamber, and the second pressure is supplied to the second chamber.

6. The transporter according to claim 4, wherein
the pneumatic actuator is a pneumatic artificial muscle actuator.

7. The transporter according to claim 1, wherein
the joint comprises a guide mechanism, the guide mechanism having a sliding surface formed in a curved shape, and
the holder is configured to change a posture of the holder along the sliding surface of the guide mechanism.

8. The transporter according to claim 1, wherein
the actuator comprises a plurality of pneumatic actuators provided in parallel with respect to the holder, and the plurality of pneumatic actuators are configured to drive individually from each other.

9. The transporter according to claim 1, wherein
the holder comprises a suction mechanism configured to suction the object.

10. The transporter according to claim 9, wherein
the holder comprises a base supported by the joint, and
the suction mechanism comprises a suction part, a movable part, and a joint part, the suction part is configured to suction the object, the movable part is supported by the base and is movable in a direction toward the base from the object, and the joint part rotatably connects the suction part and the movable part.

11. The transporter according to claim 1, further comprising:
a force sensor configured to detect a force acting on the holder,
wherein the controller is configured to change the stiffness of the joint, based on a detection result from the force sensor.

12. The transporter according to claim 11, wherein
the controller is configured to change the stiffness of the joint, based on information related to at least one of weight of the object and a center of gravity of the object which are obtained from the detection result.

13. The transporter according to claim 11, further comprising:
an arm device configured to move the holder,
wherein the controller is configured to change the stiffness of the joint, based on information which is obtained from a movement plan of the arm device.

14. The transporter according to claim 11, wherein
the actuator is configured to drive the joint, and
the controller is configured to control the actuator to reduce vibration of the object, based on information related to the vibration of the object which is obtained from the detection result.

15. The transporter according to claim 11, further comprising:
an obstacle sensor configured to detect an object around the holder,
wherein the controller is configured to change the stiffness of the joint, based on information which is obtained from a detection result from the obstacle sensor.

16. A transporter comprising:
a holder configured to hold an object;
a joint configured to support the holder and to allow a change in posture of the holder;
an actuator configured to output an adjustment force adjusting a posture of the holder; and
a controller configured to control an amount of the adjustment force.

17. A transport method comprising:
causing a holder to catch an object while maintaining a first state of a joint, the joint being configured to support the holder and to allow a change in posture of the holder in the first state; and
transporting the object while maintaining a second state of the joint, stiffness of the joint in the second state being greater than the stiffness of the joint in the first state.

18. The transport method according to claim 17, further comprising:
detecting a non-holding portion of the holder after the holder holds the object, the non-holding portion being a portion which does not hold the object; and
causing the non-holding portion to come close to the object.

19. The transport method according to claim 17, further comprising
controlling the stiffness of the joint in the second state based on information related to at least one of weight of the object and a center of gravity of the object.
